(19) United States
(12) Patent Application Publication
(10) Pub. No.: US 2004/0078300 A1
(43) Pub. Date: Apr. 22, 2004

(54) Method and apparatus for progressive information querying on proprietary data and for the progressive selling of information

(76) Inventors: John R. Smith, New Hyde Park, NY (US); Philip S. Yu, Chappaqua, NY (US); Brent T. Hailpern, Katonah, NY (US); Chung-Sheng Li, Scarsdale, NY (US)

Correspondence Address: Anne Vachon Dougherty, 3173 Cedar Road, Yorktown Heights, NY, 10598, US

(21) Appl. No.: 10/426,176

(22) Filed: Apr. 29, 2003

Related U.S. Application Data
(63) Continuation-in-part of application No. 09/236,687, filed on Jan. 25, 1999, now abandoned.

(51) Int. Cl. G06F 17/60

(52) U.S. Cl. 705/27; 705/26

(57) ABSTRACT

A system and method for progressively querying proprietary information wherein access to the proprietary information is established in a plurality of query plans that provide proprietary information protection based on at least one of query restrictions, data access restrictions, result filtering, and result transformation. Results may be provided to a requesting user by first selling coarse views of the information and then by selling additional residual views that build up details of the information; by offering and promoting the sale of views based on the potential for deriving and synthesizing additional views; by charging based on the view data transmitted, synthesized, derived, processed, or otherwise made available to the customer; and by selling and tracking the rights to the views of the information based on the dependencies among the views.

### CROSS REFERENCE TO RELATED APPLICATION

This application is a Continuation in Part of U.S. patent application Ser. No. 09/236,687, entitled “Method and Apparatus for the Progressive Selling of Information, filed Jan. 25, 1999 (YO998-417).

### FIELD OF THE INVENTION

The present invention relates to a method and apparatus for progressively querying on proprietary data, which uses sources with multiple prices and searches at multiple efforts, and for progressively selling information by first selling coarse views of the information and then by selling successive residual views that build up details of the information; for offering and promoting the sale of views based on the potential for deriving and synthesizing additional views; for charging based on the view data transmitted, synthesized, derived, processed, or otherwise made available to the customer; and for selling and tracking the rights to the views of the information based on the dependencies among the views. The invention more specifically relates to executing a query on proprietary data to produce partial results for the user and further providing a progressive querying method allowing the user to request more detailed query results after reviewing the partial results based on some charging method.

### BACKGROUND

Networked information systems such as the Internet offer great opportunities for carrying out on-line business transactions involving material goods and information. A growing number of on-line businesses deal with the sale of digital content on the Internet such as images, video, and audio. Sample applications include the sale of stock photography, on-line news, electronic and interactive magazines, digital libraries, digital audio and music distribution, and video-on demand. Networked data sources allow users to search distributed repositories to find information. Data and content providers would like to charge users for information access. At the same time, since the users have many options for seeking and obtaining information, it is often in the interest of the data providers to allow users to access some smaller amounts of information with lower cost or with no fee in order to entice the users to pay for more detailed or more complete information or results.

Should one want to perform data mining to extract selected information from a broad data space, and there is a cost associated with at least some portion of that data space, one of a variety of charging approaches may be taken. For example, the user can either pay for complete access to the database or can pay nothing and not access the database. Under this first example, the user may end up paying if they think that the database may contain useful information; however, they would have no way of knowing in advance if the access will be useful. As an alternative approach, the database provider can offer abstracts at no charge, with the user deciding whether to pay per use or to buy a subscription based on the abstracts. The utility of such a scheme depends largely on the quality of the meta-information in the abstract and on the appropriateness of the meta-information to the user's query. Yet another approach is to provide a user with free summaries that have been assembled by someone other than the database provider. Other web pages which have searched the proprietary data may publish statistical summaries or selective abstracts which the user can query and view before determining whether they wish to pay for better access to the actual source database. Still other access and pricing schemes can offer different levels of access to different users of the same database. In the latter case, a so-called “premium” patron may have access to more data sources in the database or may be offered more query results than a non-premium patron.

In database systems, methods have been developed for computing approximate queries. Generally, these techniques have been developed not to enable a business model based on multi-level access, but to allow faster response in computing answers from sampling or from unstable data. For example, S. Acharya, et. al have taught in the “Aqua approximate query answering system,” in ACM SIGMOD Record, Proceedings of the 1999 international conference on Management of Data, June 1999, Volume 28 Issue 2, a method for computing approximate answers by querying on synopses of database which involves special statistical summary data. Likewise, S. Acharya, et. Al, have taught in “Join synopses for approximate query answering” in ACM SIGMOD Record, Proceedings of the 1999 international conference on Management of Data, June 1999, Volume 28 Issue 2, a method for computing approximate queries on samples from base relations, which applies to arbitrary joins with foreign keys.

However, the multi-level access paradigm can be applied to a variety of information such as variable drilldowns in OLAP, in which different amounts of computing are used depending on time or cost bounds. For example, J. Shanmugasundaram, et al. have taught in “Compressed data cubes for OLAP aggregate query approximation on continuous dimensions,” in Proceedings of the fifth ACM SIGKDD international conference on Knowledge discovery and data mining, August 1999, a method for compressed representation of data cubes that allows approximate yet relatively accurate computation of answers to queries. Likewise, J. R. Smith, et al. have taught in “Dynamic Assembly of Views in Data Cubes,” in Proceedings of ACM Principles of Database Systems, June, 1998, a method for wavelet-based representation of data cubes that allows interactive drill-down and roll-up and progressive building of views of the data cubes over a network.

However, what is needed is a method for using sources with multiple prices as well as searches at multiple efforts. The multiple prices and searches at multiple efforts can map to the multiple levels of details, such as in the OLAP and multimedia contexts, but more generally correspond to multiple offerings from the information provider that capture some essence of a common information source.

Due to its underlying digital signal structure, digital content such as images, graphics, video, 3-D models, audio and multimedia documents is amenable to being segmented or represented in various levels of detail. For example, an image or video can be depicted at low-resolution to provide a coarse view, or thumbnail sketch. Taking advantage of the multi-resolution nature of images and video, systems have been developed for progressive transmission (see: A. Ortega, Z. Zhang and M. Vetterli, Modeling and Optimization of a Multiresolution Remote Image Database, In Proc. IEEE Infocom, 1994). Progressive transmission involves first transmitting the data corresponding to a coarse view of the information, and subsequently transmitting additional data that adds more detail. In applications such as image databases and digital libraries, the user can often make an assessment from the coarse views as to whether or not the content is relevant to their needs. This allows the data transmission for the irrelevant items to be stopped at an early stage in order to conserve network resources or to speed up the searching or browsing processes.

There are many ways in which to develop the multi-resolution representation of images in order to enable progressive retrieval. The JPEG image compression standard defines a redundant multiple resolution format for representing images in a form suitable for progressive transmission (G. Wallace, The JPEG still picture compression standard, IEEE Transactions on Consumer Electronics Vol. 38, No. 1, February, 1992). Burt and Adelson developed a Laplacian pyramid representation for images that decomposes the images into a single coarse view and residual data (Image Code, IEEE Transactions on Communications, Vol. COM-31, No. 4, April, P. J. Burt and E. Adelson, The Laplacian Pyramid as a Compact 1983). The residual data in the Laplacian pyramid can be combined with the coarse view to generate image views at higher resolutions.

The wavelet transform can been used to decompose images into a non-redundant set of spatial-frequency subbands in which one of the subbands, the low-pass subband, represents a coarse view of the image, and the remaining subbands can be used for synthesizing the views at higher resolutions (M. Vetterli and K. Kovacevic, Wavelets and Subbands Coding, Prenctice-Hall, Englewood Cliffs, N.J., 1995). Smith and Chang developed a space and frequency graph (SFGraph) for representing the image views that correspond to different spatial segments depicted at different resolutions (J. R. Smith and S.-F. Chang, Joint Adaptive Space and Frequency Basis Selection, Proc. IEEE International Conf. on Image Processing (ICIP-97), October, 1997). A non-redundant video view element graph representation has also been developed which enables progressive video retrieval over the Internet in which residual data is added to the views of a video sequence to build up details spatially or temporally (J. R. Smith, VideoZoom: a Spatio-temporal video browser for the Internet. In SPIE East—Multimedia Storage and Archiving Systems III, Boston, Mass., November 1998).

In many of the progressive representations, dependencies can be defined among the views. For example, in the case of the wavelet transform, the synthesis of an image view at a particular resolution requires access to and processing of some of the wavelet subbands by a wavelet synthesis filter bank. Methods are taught in co-pending patent application Ser. No. 079,986, by V. Castelli, C.-S. Li and J. R. Smith, entitled Interactive representation and retrieval of multi-dimensional data using view elements, filed May 15, 1998 and assigned to the present assignee, for determining the dependencies among the image views in the SFGraph. Given an image view in the SFGraph, it can be determined what other views can be derived from the given view. It can also be determined what additional view data is needed to synthesize other image views that can not be derived directly from the given view.

A view dependency approach towards processing on-line analytical processing (OLAP) queries in decision support system (DSS) databases is taught in J. R. Smith, V. Castelli, A. Jhingran, C.-S. Li, Dynamic assembly of views in data cubes. In Proc. Principles of Database Systems (PODS), Seattle, Wash., June, 1998). In the proposed view element framework, the answers to queries are represented by the views in a view element graph data structure. The view element graph can be used to determine the dependencies among the OLAP queries. For example, given the results from an OLAP query, it can be determined what additional OLAP queries can be answered by further processing the results. It can also be determined what additional view element data is needed in order to answer other OLAP queries that cannot be directly derived from the query results.

As the amount of business transactions involving information increases on the Internet, there is a growing need for combining the selling of information with the progressive representations and retrieval methods for transmitting information. Since there can exist complex dependencies among the pieces of data in a progressive information representation for the forming of views of the information, that complexity carries over into the progressive selling of information

In selling views of information, there are, again, many ways in which to price and provide the views. Often, the customer will purchase multiple views of the same information. In many cases, the views will have dependencies among them, including the instances in which views can be used to derive other views, and in which views can contribute data for synthesizing other views. It is possible to assign prices to the views based on the amount of information in the view. It is also possible to assign prices based on the potential of the using views to derive or synthesize other views. It is also possible to assign prices based on the processing needed to be performed for deriving or synthesizing the views.

In selling the customer rights to the information, there are also many ways in which to sell the rights to the views. It is possible to sell the customer the rights to use a view for display purposes only. It is also possible to sell the customer the rights to use the view to derive or synthesize other views. In selling the views of the information, many strategies can also be developed by the seller for promoting the information products and for attracting customers. For example, the seller can sell the coarse views of the information for zero or little cost. The seller can then charge a higher price for the residual view information that is needed to add detail and to build higher resolution views of the information. Also, knowing the customers' patterns of accessing the views of the information, the seller can assign prices to the views in such a way as to provide a gain for the seller.

Multi-level access, therefore, is desirable for both the querying/retrieval of information from databases as well as the delivery of retrieved information to the users, in the case of pure data, as well as for image, video, and other forms of multimedia data. For example, it may be desirable to provide access to multiple resolution images in which access to coarse image views is provided without cost while access to high-resolution views is provided for a fee. J. R. Smith has taught in “VideoZoom: Spatio-temporal video browser” in IEEE Transactions on Multimedia, 1999, a method for representing video sequences using wavelets, which allows progressive retrieval of views at multiple levels of detail in space and time.

It is therefore an objective of the present invention to provide a method and apparatus for progressive retrieving and/or querying on proprietary data which uses sources with multiple prices and searches at multiple efforts.

It is another objective of the present invention to provide a method and apparatus for delivering retrieval results in accordance with a progressive pricing scheme.

### SUMMARY OF THE INVENTION

In accordance with the aforementioned needs, the present invention is directed towards an apparatus and method for executing a query or other retrieval request on proprietary data to produce a partial result for the user, and further providing a progressive retrieval method allowing the user to request more detailed query results after viewing the partial results and the progressive fee information. Another aspect of the invention is directed to progressively selling information by first selling coarse views of the information and then by selling additional residual views that build up details of the information; offering and promoting the sale of views based on the potential for deriving and synthesizing additional views; charging based on the view data transmitted, synthesized, derived, processed, or otherwise made available to the customer; and selling and tracking the rights to the views of the information based on the dependencies among the views.

### BRIEF DESCRIPTION OF THE DRAWINGS

The invention will now be described in detail with specific reference to the appended drawings wherein:

FIG. 1 shows a networked information system that is suitable for carrying out the progressive selling of information;

FIG. 2 depicts a sample view dependency data structure showing the relationships among views;

FIG. 3 shows a sample space and frequency graph view element data structure for representing images;

FIG. 4 shows an example of the progressive selling of image views by retrieving and processing SFGraph view elements;

FIGS. 5A and 5B show analysis and synthesis filter banks for deriving and synthesizing views, and a cascade of analysis filter banks for decomposing a video sequence into a coarse view and residual views;

FIGS. 6A and 6B depict a representative video view element graph data structure and request flow showing the progressive selling of video views by retrieving and processing video view elements;

FIG. 7 shows an example of the progressive selling of video using view elements to add details temporally or spatially to a coarse view of a video sequence;

FIG. 8 shows a flowchart depicting the exchange between the information seller and customer in the selling of views of the information;

FIG. 9 shows a flowchart depicting the exchange between the information seller and customer in the progressive selling of views of the information in which first coarse views of the information are sold to the customer and then more detailed views are sold to the customer;

FIG. 10 shows a flowchart depicting the steps performed by the information seller in preparing, selling and providing the views of information to the customer;

FIG. 11 shows a depiction of the handling of multiple requests for the view information that the customer has purchased rights to, where the customer accesses the view information from different client devices;

FIG. 12 shows a networked information system that is suitable for carrying out the progressive querying of information;

FIG. 13 depicts a more detailed example of a general query server having features of the present invention;

FIG. 14 shows a sample query interface for a free user;

FIG. 15 shows a sample query interface for a paid user;

FIG. 16 is an example of the logic query plan management routine;

FIG. 17 is an example of the query plan execution routine; and

FIG. 18 shows an example of an optimization of the query plan execution routine

### DETAILED DESCRIPTION OF A PREFERRED EMBODIMENT OF THE INVENTION

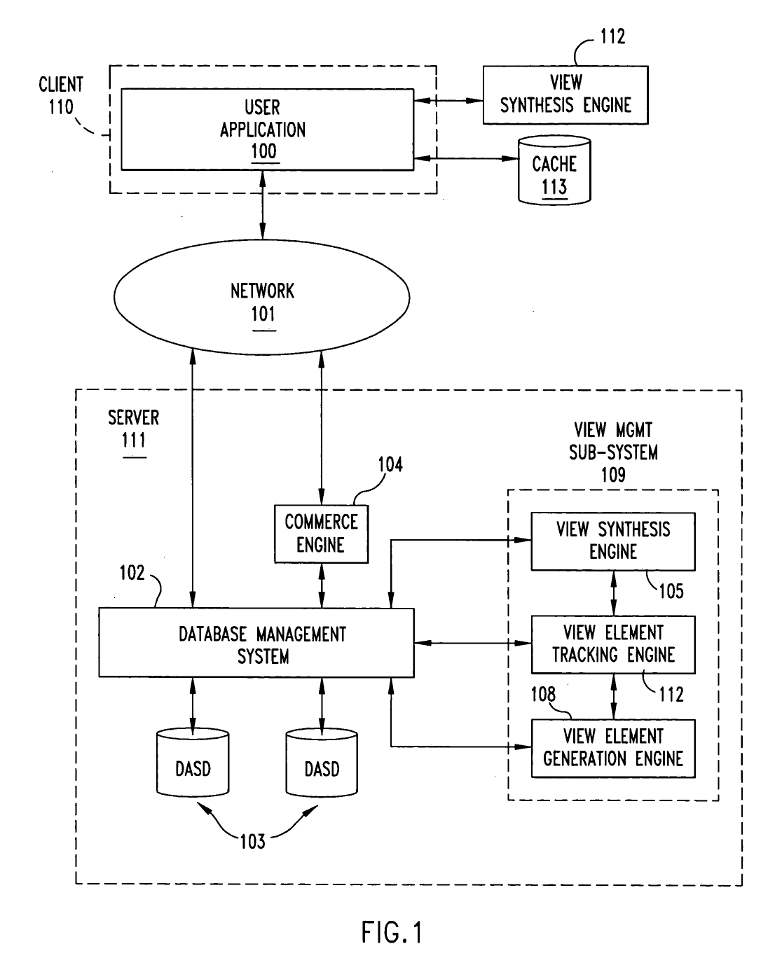

FIG. 1 depicts an example of a networked client-server system having features of the present invention. As depicted, one or more client locations (110), and server locations (111) are interconnected by a network (101). Examples of networks are local area networks (LANs) or wide area networks (WANs), e.g., an intranet or the Internet or the World-Wide Web (WWW). The client device (110) is running a user-application (100) that accesses the views of the information at the server (111). The user-application can make use of a local cache (113) that can store previously retrieved view information. The user-application can also make use of a view synthesis engine (113) that can process retrieved view information to derive and synthesize new views.

The server (111) offers information views for sale. The offering can be made through the network (101) to the client (110) by publishing the offer on the World-Wide Web. The user-application (100) purchases the views of the information by communicating a request through the network (101) to the server (111). The server can have a commerce engine (104) that establishes customer accounts, handles the purchases, and sells the view information. In response to a request to purchase view information, the request can be passed onto a database management system (102) which retrieves the needed data from one of a potential plurality of direct access storage devices (DASD) (103). The retrieved data can then be passed on to a view management subsystem (109) which processes the data in order to generate the requested purchased view information.

The view management subsystem (109) can generate the view information by using view element generation engine (108) to perform analysis and synthesis operations on the data. In some cases (i.e., progressive retrieval), the client (110) has already purchased some of the view elements that are needed to generate the requested view. In these cases, a view element tracking engine (112) can detect the view elements that already reside at the client and process only those additional view elements that are needed. The additional view elements can be transmitted directly to the user-application (100) which combines these view elements with those stored in the client cache (113) by using the view synthesis engine (105) in order to synthesize the view. Alternatively, the view synthesis can be performed at the server using the view synthesis engine (105) and the view can be transmitted to the client (110) through the network (101).

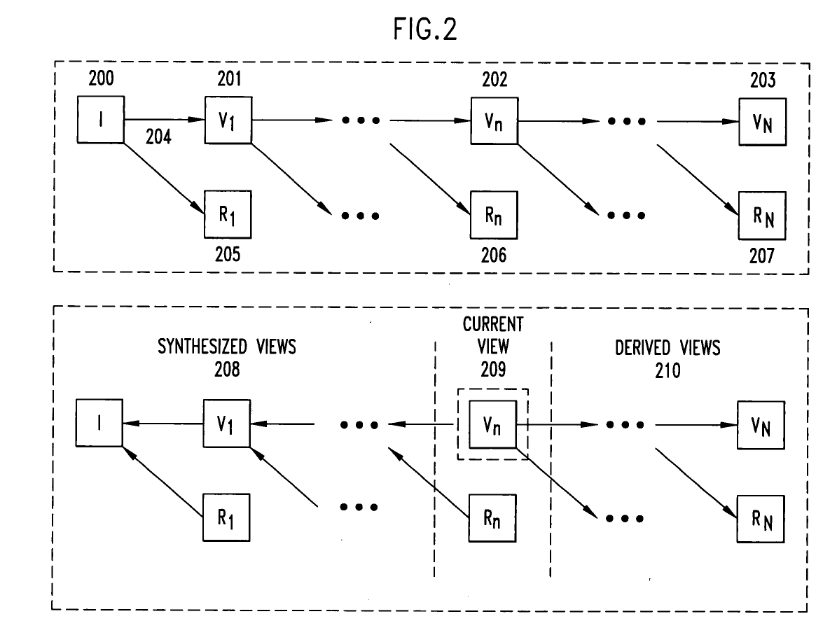

FIG. 2 depicts a view dependency data structure that shows a number of dependency relationships among views. In this example, a given information object I (200), which can be an image, video, audio track, 3-D model, and so forth is successively decomposed into coarse views (201, 202, 203) and residual views (205, 206, 207). In the first stage of the decomposition of the information object I (200), a single coarse view is generated V₁ (201). This coarse view can be, for example, a low-resolution version of an input image or a low-resolution version of an input video. The first stage also generates a residual view R₁ (205). The residual view R₁ can have the property that when combined with the coarse view V₁, the original information object I is reconstructed. The decomposition can be iterated on the coarse views, i.e., V₁, to decompose the original information object I into a plurality of sets of coarse and residual views ({Vn, Rn} . . . {VN, RN}) to form the view dependency hierarchy.

Given the view dependency data structure, the data dependency among the views can be determined. For example, given one view, such as Vₙ (209), there is a set of derived views (210) that can be generated directly by processing Vₙ. In a progressive information selling environment, if the customer has purchased the view Vₙ, then the customer can potentially obtain the derived views (210) by processing the purchased view. On the other hand, other coarse views such as V₁ cannot be derived directly from the given view Vₙ (209), when n>1. The set of synthesized views (208) require the additional residual view data such as R₁.

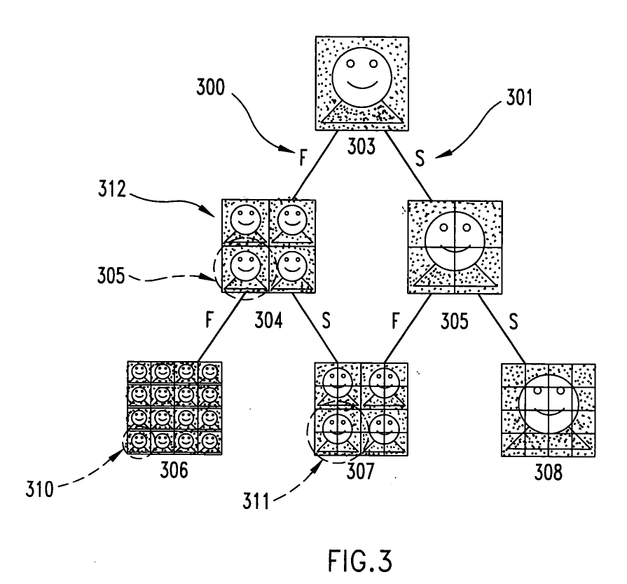

FIG. 3 shows an example of a space and frequency graph (SFGraph) view element data structure for images. The images (303) are iteratively decomposed using a quad-tree spatial segmentation operator (S at 301) and using a four-subband filter bank spatial-frequency segmentation operator (F at 300). The SFGraph generates coarse versions of the image (309, 310), and coarse versions of parts of the image. The SFGraph also generates residual data that can be combined with the coarse data to synthesize more detailed image views. For example, by combining the coarse image view (309) with the three residual views (312), the image can be synthesized at full resolution (303).

In the progressive selling of views of the image using the SFGraph, the seller can offer the customer any of the views in the SFGraph. The customer can initially purchase some of the views and display them. Later, the customer may want more detailed versions of the views. The seller can offer the customer additional residual data that can be combined with the previously purchased views that will allow the customer to generate more detailed views. The seller can also provide the user with the necessary program, such as a Java applet or Web browser plug-in, that can perform the required view synthesis for the customer. Alternatively, the seller can perform the view synthesis on behalf of the customer, and provide the customer with the synthesized view directly.

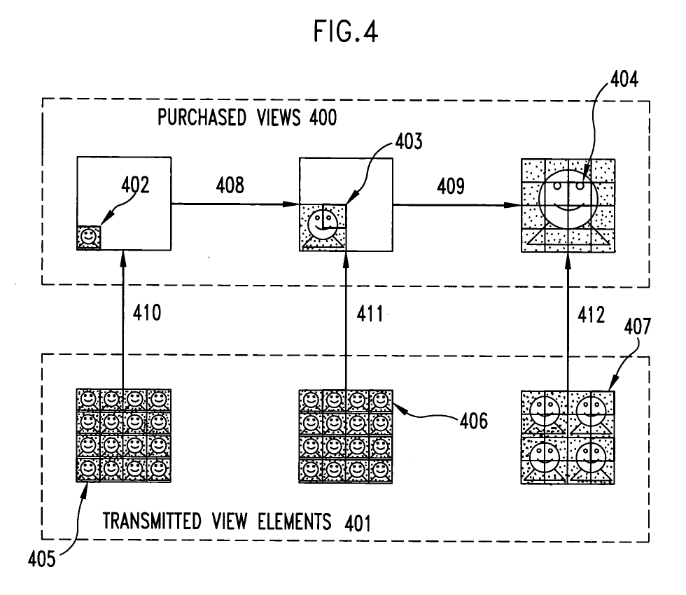

FIG. 4 shows an example of the progressive selling of image views using the SFGraph. FIG. 4 shows the potential difference, in the process of progressive selling, between the actual purchased views (400) and transmitted view elements (401). Initially, the customer purchases a coarse view of the image (402). The seller provides this view by transmitting the view (405) directly to the customer in transmission step (410). The customer then requests view (403) which has more details on the upper-right quadrant of the image. The seller provides this view by transmitting the needed view elements (406) to the customer in the transmission step (411). The customer combines these view elements with the view (402) in a processing step (408) to synthesize the view (403). This process is repeated as the customer purchases the more detailed view (404) and only the residual view elements (407) are transmitted by the seller in transmission step (412), as view (403) is combined with view elements (407) in a processing step (409) to generate the view (404).

There are many ways in which the seller can charge the customer. The seller can charge the customer only for the accessed view elements (405, 406, 407). Alternatively, the seller can charge the customer for the accessed views (402, 403, 404). Alternatively, the seller can charge the customer for the amount of data transmission over the network (410, 411, 412). In yet another alternative, the seller can charge the customer for the processing needed to generate the more detailed views (408, 409).

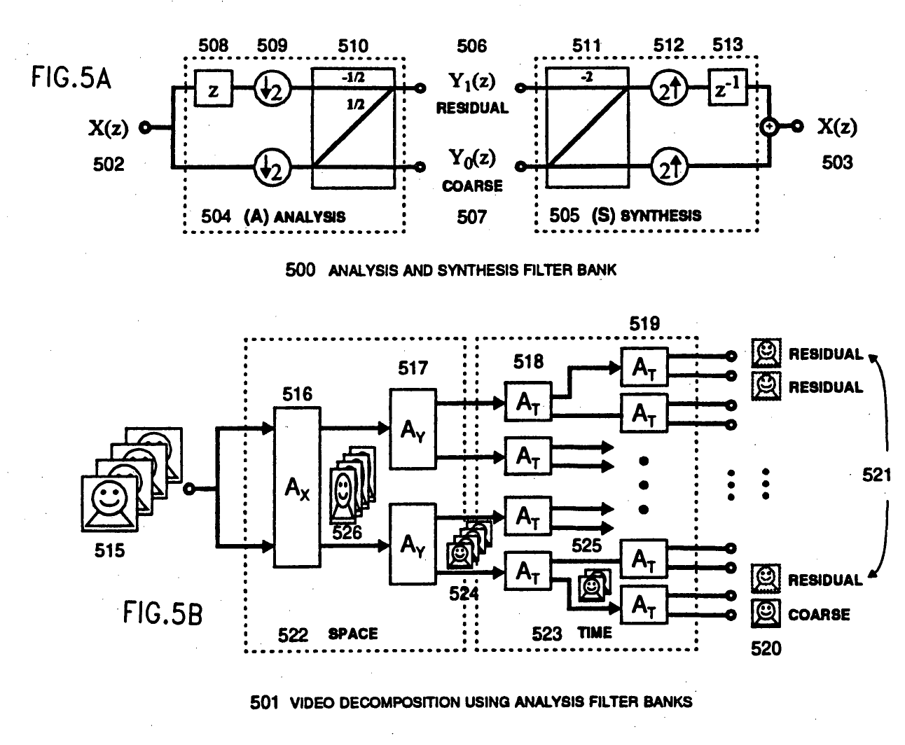

FIG. 5A shows a representative analysis and synthesis filter bank for deriving and synthesizing views, and a FIG. 5B shows a cascade of analysis filter banks for decomposing a video sequence into a coarse view and residual views. The analysis and synthesis filter bank is made up of an analysis component A (504) and a synthesis component S (505). The analysis filter bank decomposes the input X(z) (502) into a coarse view Y₀(z) (507) and a residual view Y₁(z) (506). Using the elements of the analysis filter bank shown in (508, 509, and 510), the coarse view Y₀(z) (507) corresponds to a low-frequency version of the input X(z) (502), and the residual view Y₁(z)(506) corresponds to a high-frequency version of the input X(z) (502). For many types of input data X(z) (502), such as images, video and audio, the coarse view Y₀(z) (507) serves well as a thumbnail sketch of the input data X(z) (502).

The analysis and synthesis filter banks in (500) are shown in polyphase form. The input X(z) (502) is first split into odd and even terms using a delay shift z (at component 508) and down-sampling by two (at sampler 509). Then, the terms are weighted and combined as illustrated in processor 510 to form the coarse view Y₀(z) (507) and a residual view Y₁(z) (506).

The input data X(z) (502) can be resynthesized using the synthesis filter bank by processing the coarse view Y₀(z) (507) and a residual view Y₁(z) (506) as shown in synthesis component (505). The coarse view Y₀(z) (507) and a residual view Y₁(z) (506) are first weighted and combined as shown at 511, then are upsampled by two (at sampler component 512). In one path the data is shifted z⁻¹ (at shift component 513) and then the data in the two paths is combined to resynthesize the input data X(z) as output at 503.

The analysis and synthesis filter bank shown in 5A is a perfect reconstruction filter bank in that the input data is perfectly reconstructed from the coarse view Y₀(z) (507) and a residual view Y₁(z) (506). Other perfect reconstruction filter banks can be created using different filters, such as the Haar filter. It is also possible to define different operators in the analysis filter bank (504) for partitioning the input data X(z) (502) into segments. In such a segmenting case the synthesis filter bank (505) would compose the segments together to reconstruct the input data. While the synthesis component is taught as residing at the seller location, it may also be duplicated at the customer location.

Also shown in FIG. 5B is the cascade of analysis filter banks (501) that decomposes a video sequence in space and time. Using this cascade, each input set of four view frames (515) is decomposed into 16 view elements (520 . . . 521), where 520 corresponds to a coarse view of the frames, and 521 represents the 15 residual view elements.

In this cascade, the analysis filter bank (504) first decomposes along the x-spatial dimension of the four frames. This generates an intermediate coarse view of the frames shown in (526). Next, the analysis filter bank (504) decomposes along the y-spatial dimension of the data, which generates another intermediate coarse view as shown at 524. Finally, the analysis filter bank (504) is twice iterated on the data along the t-temporal dimension, which generates the coarse view (520) and residual views (521). The coarse view (520) provides a 1/16^{th} thumbnail sketch of the input video (515).

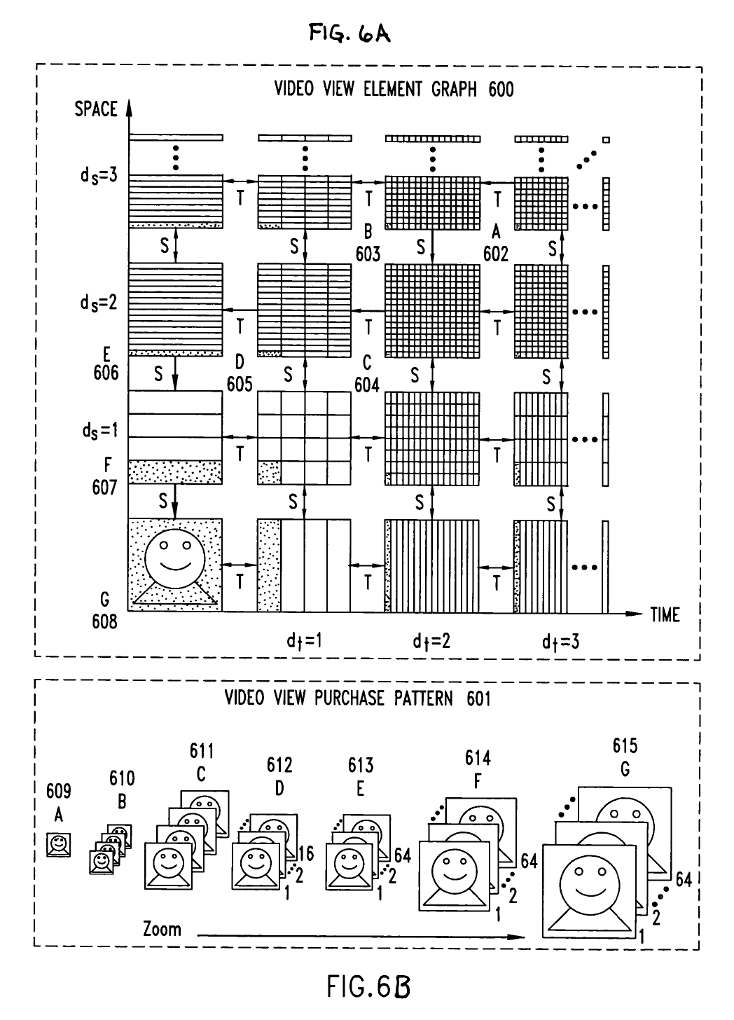

FIGS. 6A and 6B show how the progressive selling of views of information can be applied to video. The video view element graph (600 of 6A) decomposes the video sequence into spatio-temporal view elements. Some of the view elements correspond to low-resolution views of the video sequence (such as 602, 603, 604, 605, 606, 607) while other view elements correspond to residual data.

The customer can purchase views of the video sequence in a progressive manner. One example video view purchase pattern is shown in (601 of FIG. 6B). The customer initially requests view A (609). The seller provides the customer with the view A by retrieving view (602) from the video view element graph (shown in 600). The customer then wants to add more details to the view along the temporal dimension and, therefore, requests view B (610). This view, which corresponds to view (603) in the video view element graph of 6A can be provided directly to the customer, or can be synthesized from residual video view element data from the video view element graph (600) when combined with previously purchased view (609) at either the seller's or the customer's location.

This process can be repeated as the customer progressively buys more detailed views from the seller. Each iteration allows the customer to purchase more details along the temporal dimension (as in 612, 613) or spatial dimension (as in 611, 614, 615). Since these view correspond to view elements in the video view element graph, the seller can utilize the dependencies among the view elements to determine the appropriate mechanism for providing the views to the customer, such as providing only the needed residual view element data (assuming that the customer has access to a view synthesis engine) or providing the view directly.

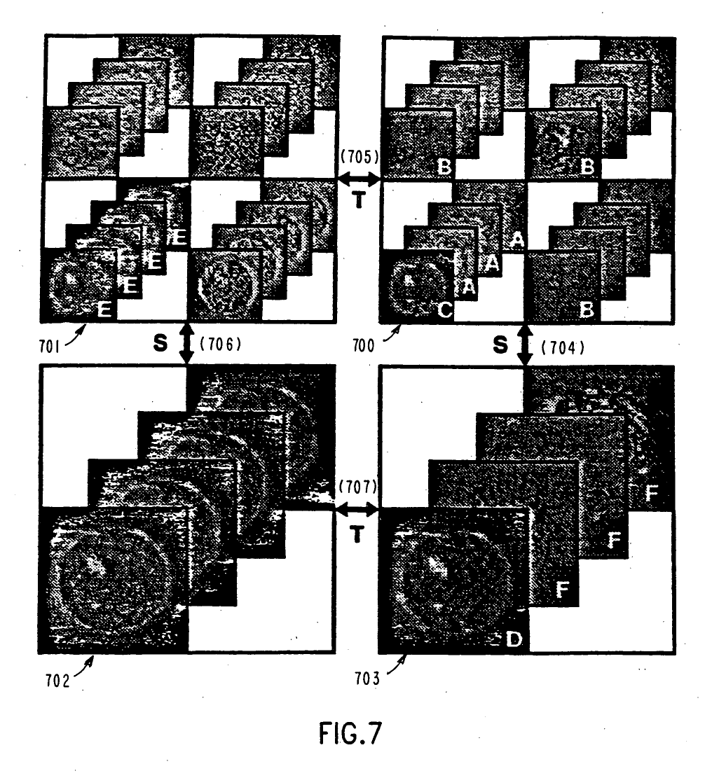

FIG. 7 shows an example of the progressive selling of video using view elements to add details temporally or spatially to a coarse view of a video sequence. The video view dependency structure shows the dependencies among the video view elements for adding details temporally (705, 707) and spatially (704, 706). The original video sequence is represented by the set of frames in (702). Some of the view elements in the view element data structure are coarse views of the video sequence (labeled E (701), C (700) and D (703)). The remaining view elements are residual view elements (i.e., some are labeled A and B).

Given a coarse view of the video, view C (700), details can be added spatially to generate view D (703). The details can be provided to the customer by selling the customer the view elements labeled B. Alternatively, details can be added temporally to generate view E (701), by providing the customer with the view elements labeled A.

If instead, the customer has started by purchasing the coarse view of the video D (703), a more coarse view C (700) can be derived directly from D at the customer's location without purchasing new view elements. However, the view elements F must be purchased from the seller in order to allow the user to obtain access to the more detailed view (702).

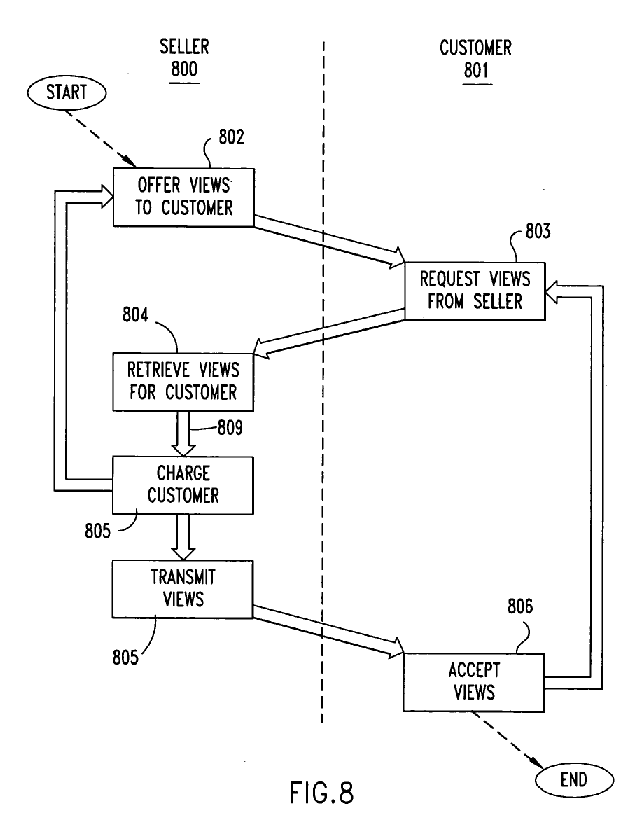

FIG. 8 shows a flowchart depicting the exchange between the information seller (800) and customer (801) in the selling of views of the information. The seller (800) starts by offering views of the information to the customer in step (802). The information can be digital content such as a photographic image, graphic, video, 3-D model, animation, audio, music, midi object or other type of n-dimensional lattice data or digital signal. The information can also be structured data such as a relational database or relational table. The views of the information can correspond to the information depicted at different spatial, temporal or frequency resolutions, viewing angles or distances, frame rates or viewing qualities. For example a thumbnail image corresponds to a depiction of an image a lower spatial resolution. Similarly, a video sequence missing some of the frames corresponds to a depiction of the video at a lower temporal resolution. A highly compressed version of audio corresponds to a depiction of the audio at lower fidelity. A view of audio, digital music or midi object can correspond to the information depicted at different data rates or using different channels, instruments, tracks. The views can also be depictions of portions of the information such as spatial pieces of images, or temporal segments of video or audio. The views can also correspond to different renditions of the information in which portions of the information are blocked out, covered up, removed or rendered differently. In the case of relational databases and relational tables, the views can correspond to projections of data cubes generated from the relational data, or can correspond to segments of the data cubes.

In step (802) the seller offers the information views to the customer and optionally uses advertising or promotions in order to attract business from the customer. The seller can make offers that promote the potential of the customer to display and playback the views, but also for deriving and synthesizing other views of the information. The customer may decide to purchase the views and, if so, informs the seller in step (803) with a request for purchase. The seller receives the purchase request and starts the process of retrieving the views for the customer in step (804). The seller optionally charges the customer for the views in step (805). The seller then transmits the views to the user (805) and the customer accepts the views in step (806).

In some cases the seller transmits the views from the seller site. Alternatively, if the information views are stored at another site (not shown), the seller can authorize or trigger the delivery of the information views from that site to the customer. The seller can continue to make offers to the customer of information views, as indicated by arrow 812. The customer may decide to purchase another view or to stop.

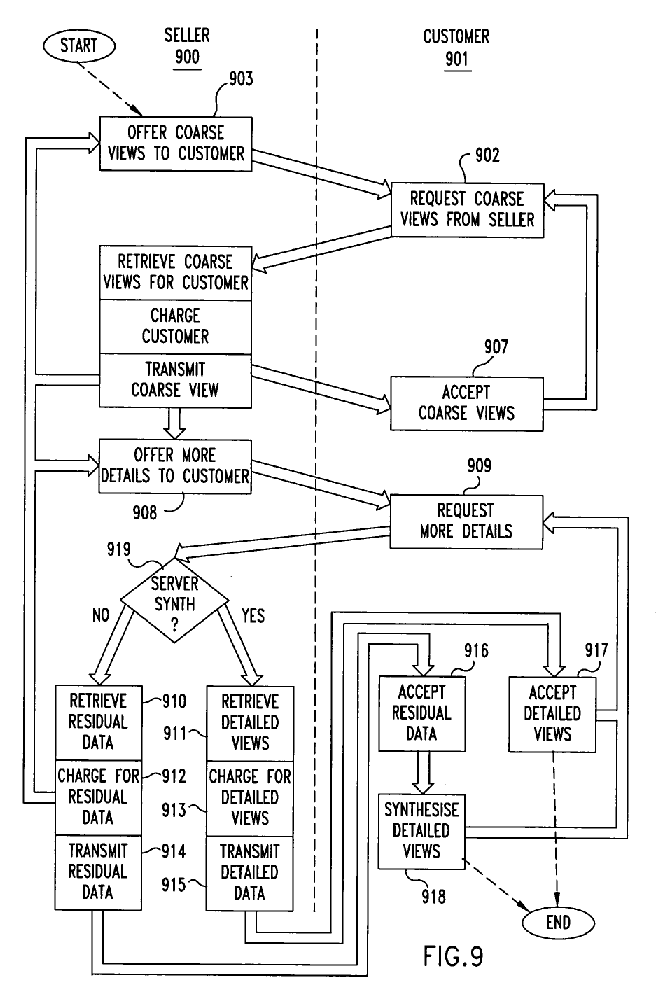

FIG. 9 shows a flowchart depicting the exchange between the information seller (900) and customer (901) in the progressive selling of views of the information in which first coarse views of the information are sold to the customer and then more detailed views are sold to the customer. This scenario differs slightly from the one in FIG. 8 in that the seller (900) takes advantage of a progressive representation of the information that allows the use of residual data to build more detailed views.

The seller starts out by offering the coarse views of the information to the customer in step (903). The coarse views are part of the progressive representation of the information, in which the coarse views can be combined with residual information to build up more detailed, or less coarse, views. The progressive representation can be implemented by adopting a view element framework in which the view elements correspond to the coarse and residual views of the information. Since the view elements can be used in a number of ways for deriving and synthesizing views, the seller (900) can make offers that promote the potential for using the view elements to derive and synthesize a number of other views.

The customer (901) may decide to purchase the coarse views of the information from the seller. The customer issues a purchase request (902) to the seller and the seller processes the purchase in step (904). The seller optionally charges the customer in step (905) for the coarse views and transmits the coarse views to the customer at (906).

The seller (900) has a number of ways in which to assign the prices and determine charges, for example, the seller may charge in step 905 based on the amount of data in the views that is transmitted to the customer in step (919). As another alternative, the seller can charge based on the amount of data or useful or relevant content in the purchased views as measured by entropy, file size or subjective evaluation. Alternatively, the seller can charge based on the amount of processing required to generate the views. In yet another alternative, the seller can charge based on a retrieval schedule designed to produce revenue from the sales such as by selling coarse views at little or no cost and later charging a higher price for more detailed views. Alternatively, the seller can assign costs based on encouraging the customer's interaction with the seller, for the purpose of exposing the customer to advertisements displayed by the seller.

The seller transmits the coarse views in step (906). After the customer accepts the coarse views in step (907), the customer may decide to respond to other view offerings of the seller and return to make additional purchases of coarse views. The seller can continue to make offers for coarse views of the information to the customer. The seller can also make additional offers to the customer in step (908) for adding more details to the coarse views already purchased by the customer. Using a progressive representation, these details can be provided by residual data that is combined with coarse data. The customer may decide to purchase more details and issue a purchase request to the seller in step (909).

The seller has different options for handling the purchase request of step 909. The seller can provide the detailed views directly to the customer (911,913,915) or provide the residual data to the customer (910,912,914). In providing the detailed views directly, the customer needs to accept the views in step (917). In providing the residual data, the customer needs to accept the residual data in step (916) and thereafter to process the residual data, possibly in combination with previously purchased coarse views, in order to synthesize the detailed views.

It is possible that the seller does not provide the residual data or detailed data directly from the seller site, but authorizes or triggers the delivery from another site (not shown). Alternatively, the seller can authorize or trigger the release, processing or retrieval of data that already resides at the customer site. For example, the user may have previously purchased coarse views in step (904). In a subsequent purchase by the customer at step 909, the customer may be sold views that can be derived from the coarse view. In this case, the transaction and processing can extract the derived view from the customer's coarse view with or without the customer's knowledge.

It is also possible that the seller delivers, along with the view data, a program (e.g., a Java program) for handling the synthesis of step (918) or other processing required for generating the views at the customer location. The program, when executing at the customer site, can interact with the seller to automatically retrieve new offers, promotions and advertisements.

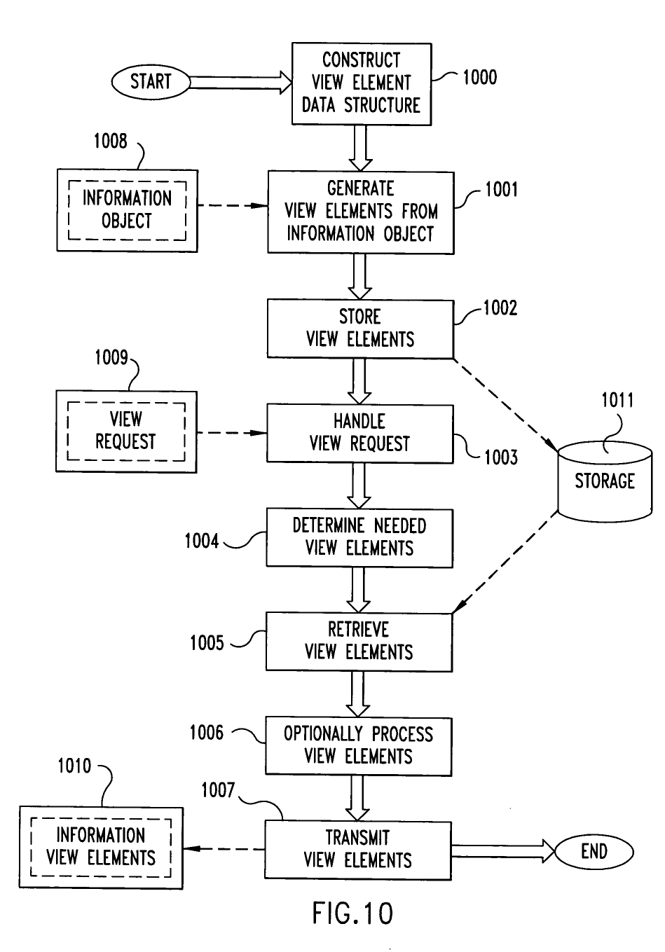

FIG. 10 shows a flowchart depicting the steps performed by the information seller in preparing, selling and providing the views of information to the customer. The seller may construct a view element data structure such as the SFGraph to manage the coarse and residual views of the information. The seller processes the information object (1008) and generates the coarse and residual views in step (1001). The coarse and residual views may optionally be represented by view elements. The view elements can be stored (1002) in an on-line or off-line storage device (1011).

The customer may issue requests (1009) for views to the seller. The seller handles the requests in step (1003) and determines in step (1004) what data is needed. The seller can use the view element data structure to make the determination. For example, give a particular view, the seller can use the dependency relationships of the view element data structure to identify the view elements on which the view depends. Given a set of view elements, the seller can determine the completeness of the set with respect to the view, where completeness refers to whether the set of views has sufficient data for deriving or synthesizing the view.

After determining what data is needed, the seller can retrieve the view elements in step (1005), and, if necessary, process them in step (1006) to generate the required view elements. These view elements can then be transmitted to the customer in step (1007).

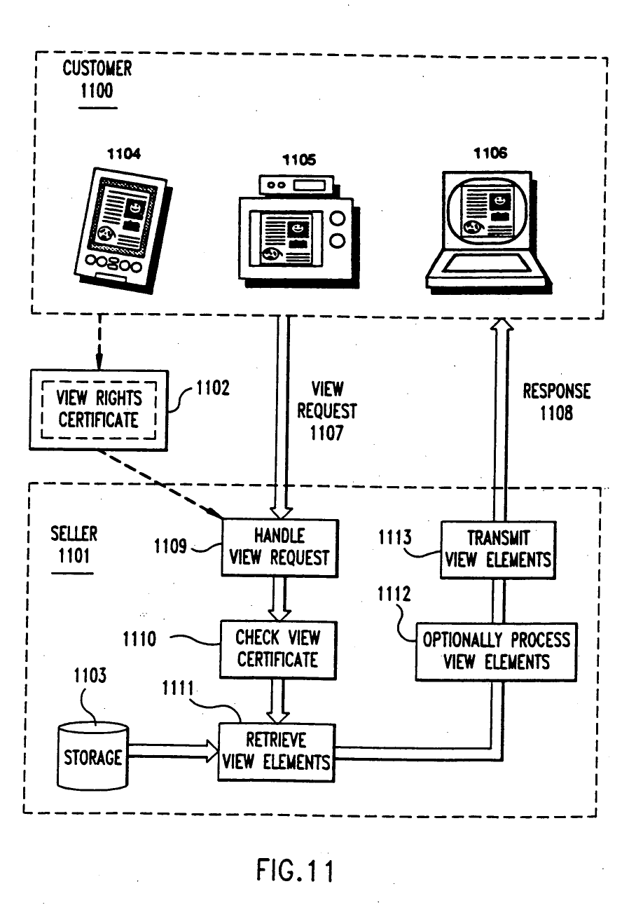

FIG. 11 shows a depiction of the handling of multiple requests for the view information that the customer (1100) has purchased rights to, where the customer accesses the view information from different client devices (1104, 1105, 1106). In many cases, the customer would like to purchase the view information, and reserve the rights to access the view information multiple times without the requirement of constraining customer resources by locally storing the view(s). This paradigm emerges in a pervasive computing environment where the customer (1100) has multiple client devices such as a personal digital assistant (104), television-based Web browser (1105), and personal computer (1106). Other types of client devices include hand-held computers, smart phones, notebook computers, digital audio receivers and playback devices, workstations, global positioning system devices, wireless wrist watches, cellular phones and pagers. The customer may use the different devices at different times to access the view information that the customer has purchased.

The seller (1101) can handle this scenario by selling the customer (1100) rights to the view information. The rights can allow the customer to access the view information multiple times. In general, the seller (1101) can separate the fee charged for the rights to the views from the fee charged for accessing, transmitting, displaying or playing-back the views by the customer. The seller (1101) can sell the customer (1100) the rights to other views which can be derived from the purchased view data, and can provide those derived views to the customer upon request. For example, if the customer (1100) purchases a view with the intention of displaying the view on a personal computer (1106), then the customer (1100) may purchase a view of fairly high-detail. However, later, the customer (1100) may want to access that view on a client device with a smaller display area, such as a personal digital assistant (1104). However, the client device may not be capable of displaying, storing or handling the highly detailed view. If the customer has purchased rights to the derived views, then these can be displayed in the device. The seller can also provide the derived views to the client.

The seller can manage view rights using a certificate (1102) or unique ID that is issued to the customer (1100). When the customer issues a view request (1107) to the seller, the customer can provide the certificate (1102) to the seller (1101). The seller can handle the view request (1109) and check the view certificate (at step 1110) for authenticity, expiration, validity and relevance. If the certificate entitles the customer to view information, then the seller can retrieve, at step 1111, process data, at step 1112, as needed, and transmit the view (1113) to the customer in the response (1108).

The seller can use a view element dependency data structure to assign and determine the view rights. For example, the purchase of the rights to a view by the customer can be fulfilled at the seller location by assigning rights to view elements in the view element dependency data structure. Since those view elements can be used in a number of ways to derive and synthesize other views, the rights can, at the seller's discretion, be transferred to other views in the view element dependency data structure. Then, if the customer (1100) requests a view for which the customer has previously obtained the rights to some of its constituent view elements, the seller (1101) can offer the customer the missing view elements, or rights to the missing view elements.

Since the capabilities of the customer's client devices may vary, the synthesis or derivation of views can be processed at the seller's sight or customer's sight. In general, the processing can be performed at a server, proxy, or client in a networked environment. When the client device capabilities are varied, or the workload at the server is high, the processing can be partitioned between server, proxy, and client in order to adapt to the client, server, and network conditions.

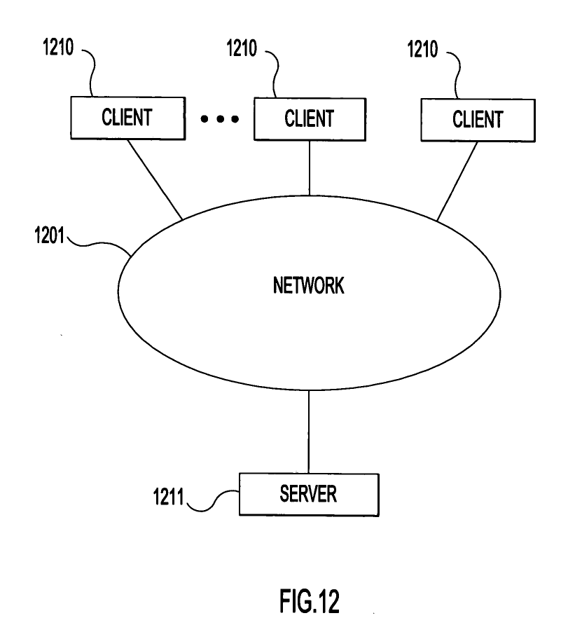

FIG. 12 depicts an example of a networked client-server system having features of the present invention. As depicted, one or more client locations (1210), and server locations (1211) are interconnected by a network (1201). Examples of networks are local area networks (LANs) or wide area networks (WANs), e.g., an intranet or the Internet or the World-Wide Web (WWW). The client device (1210) is running a user-application that issues request to search for information at the server (1211).

The server (1211) maintains proprietary information in databases and allows users or user applications to issue queries or retrieval requests (hereinafter, collectively referred to as “queries”) against the databases or against portions of the databases (e.g., a restricted view of the databases) to search for information. The server includes a query plan management (QPM) system which control the amount of information that a user can access. In the preferred embodiment, it determines (1) the type of queries a user can invoke, (2) the subset of the databases or a view of a database against which to perform the query, (3) the filtering mechanism to apply against the query result, and (4) the transformation mechanism to apply against the filtered query result. Generally speaking, the system will allow a user to issue queries without a fee only in the most restricted conditions. That is to say, the QPM will perform some sort of proprietary information handling (essentially information hiding) in order to disclose the bare minimum amount of information or query results necessary to entice the user to continue.

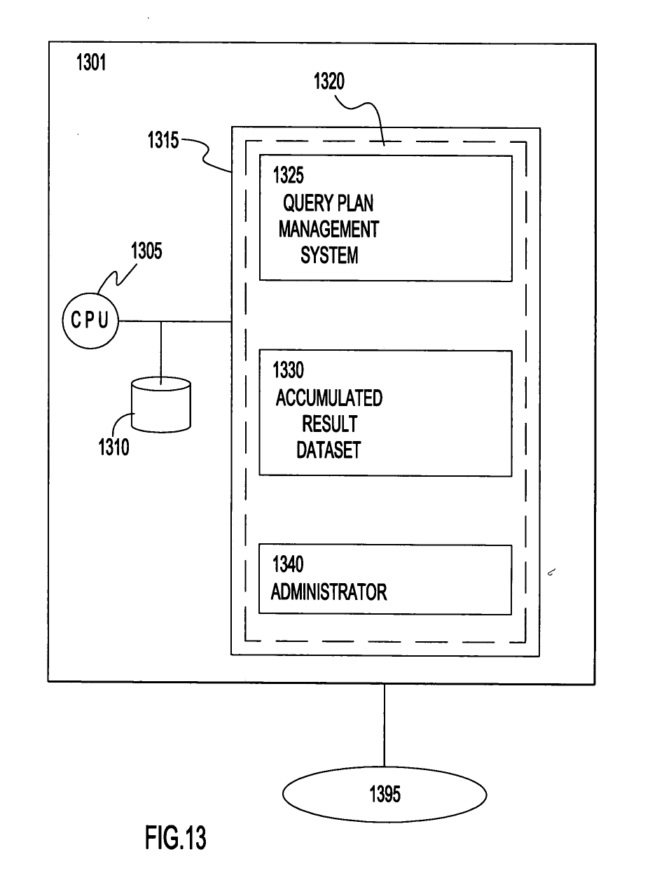

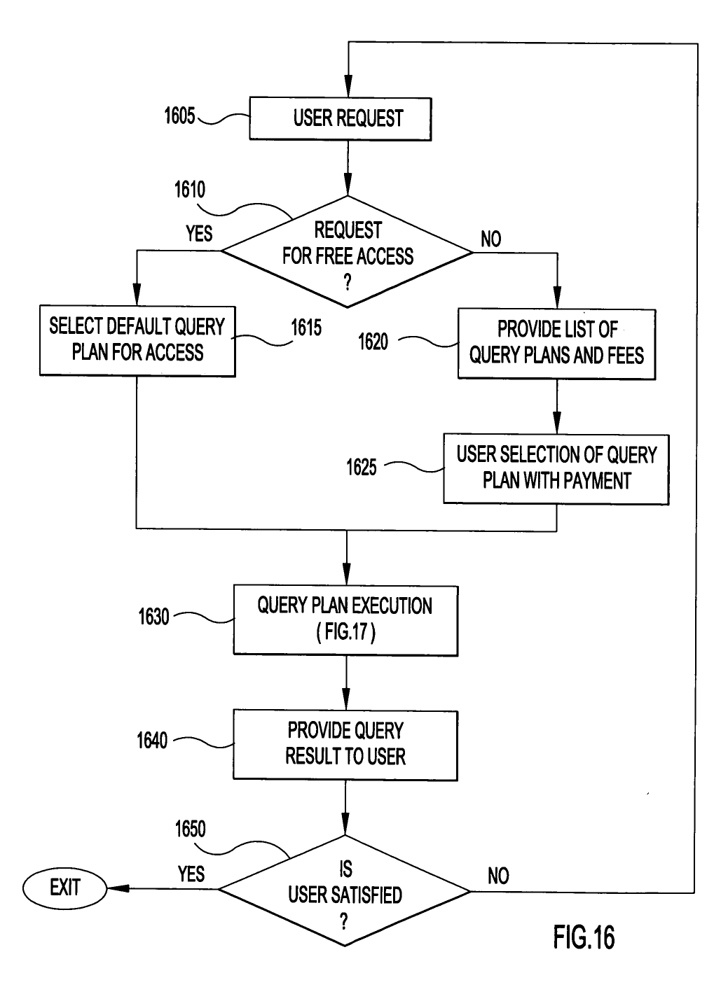

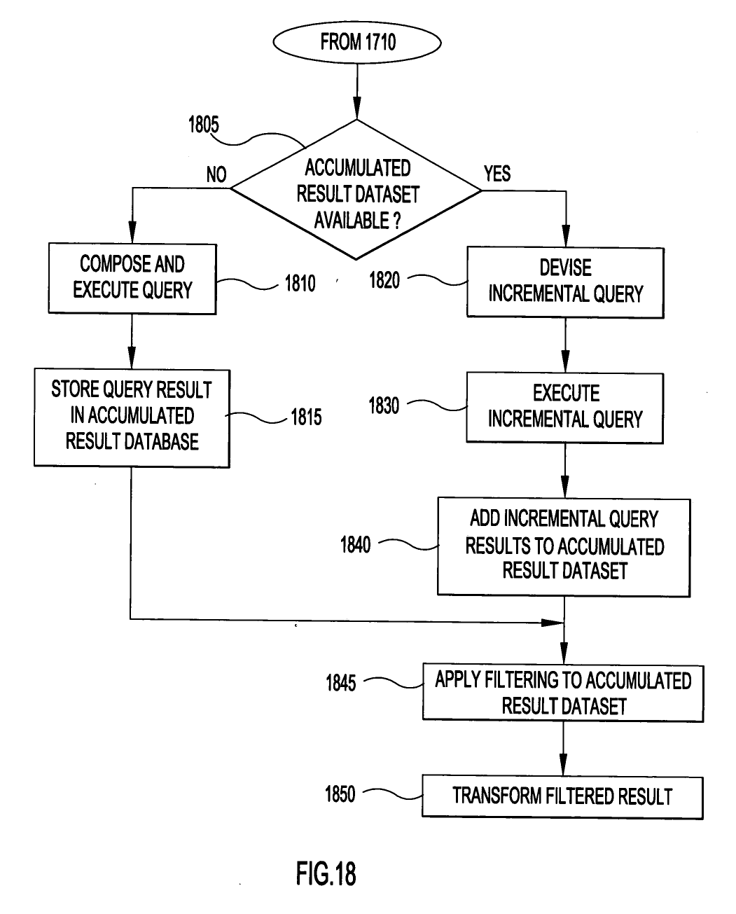

FIG. 13 depicts a more detailed example of a system having features of the present invention. As query server node (1301) is a computing node that can serve requests through the network (1395). The query server node preferably includes a CPU (1305), memory (1315) such as RAM, and storage devices (1310) such as DASD. The memory (1315) stores the server logic (1320), preferably embodied as computer executable code which is loaded from the DASD (1310) into memory (1315) for execution by the CPU (1305). The query server logic includes an query plan management (QPM) component (1325), the details of which are further described below with reference to FIG. 16. Since the system expects that a user will go through several iterations of querying, it is important to leverage any previous executions in speeding up future execution of a less restricted version of the query. Ideally, therefore, the system will maintain temporary results from previous executions of a query in an accumulated result dataset (1330) to speed up future query execution (as depicted in greater detail in FIG. 18). The illustrated administration component (1340) takes cares of various other functions to support the system. For example, it will include a customer management routine to handle customer payment, billing, etc. It will also include an administrator interface function to help an administrator to input or compose query plans and associated fee structures and a query interface to collect parameters from the users. Since these functions are not the focus of the present invention, no further details need be provided.

In the preferred embodiment, four types of proprietary information handling (i.e., protection or hiding) techniques are considered in the QPM routine. The first proprietary information handling technique is query restriction, to restrict the type of queries a user can invoke to perform the search. The second handling technique is data restriction, to restrict the query to be performed only against a subset of the databases or against some restricted view of a database or databases. The third handling technique is result filtering, which is used to apply a filtering process to the query result so as to return only a fraction of the query result. For example, if the query has found 100 items relevant to the query, the filtering process may decide that only 10 of these items are to be returned to the user as sample results. Another way of providing result filtering is to reduce the information contained on each item. For example, in querying news on a specific subject, only the headlines, and not the body of the text descriptions, are returned. The fourth proprietary information handling technique is result transformation, whereby transformations (such as encryption) may be applied to the query results, for example, to make certain portions of the text or image not readable or viewable. Those skilled in the art will appreciate that many other techniques can be performed to hide portions of the information. Further, any subset of these techniques can be applied to achieve proprietary information hiding.

Accordingly, for free queries which can be issued by any user, the system will only allow for very limited set of queries to a small subset of the databases, and will apply filtering or transformation on the query result. For example, if a user wants to search for articles on a specific topic, such as “reverse proxy”, he may only be allowed to search from a given set of topics which may include the general topic “proxy”, but not the specific topic “reverse proxy”. The query may only be performed against a particular subset of conference or publisher databases and the returned results may only include the abstracts and the first 2 pages of each paper with all figures in reduced resolutions. Nonetheless, the returned result should contain enough meaningful information to entice the users to continue the information search upon payment of the requisite fee.

To issue more effective or detailed queries to continue the information search, the server will offer different query plans from which the user can select. The less expensive the plan is, the more restrictions are imposed. Depending upon what the user is looking for, he can decide what kind of query plan is most appropriate. In any case, if the user is uncertain as to which plan will be best suited to his needs, the querying process can be carried out progressively. The user can first choose a highly restricted plan, hence paying a low fee. After the results are returned, if the results do not quite satisfy the user requirement, but do look promising, the user can progressively move up to the more comprehensive and expensive query plans.

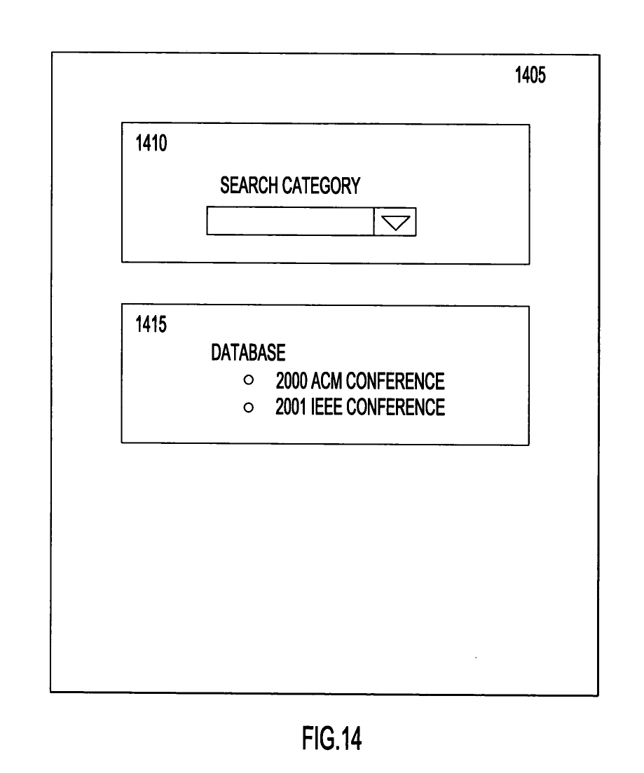

FIG. 14 depicts an example of the query interface 1405 which can be made available at no charge to users. The interface 1405 collects parameter values from a user so that a query meaningful to the user can be composed and executed. Since the so-called “free query” is only intended to give the user some idea of what the system can provide, very limited options are made available by the query interface. For example, under search category 1410, the user is allowed to select one of the topics from a pull down list to search. Under database 1415, the user can select one of the two databases to search. The intent is not to fully satisfy the user requirements, but to show the user what the system can do.

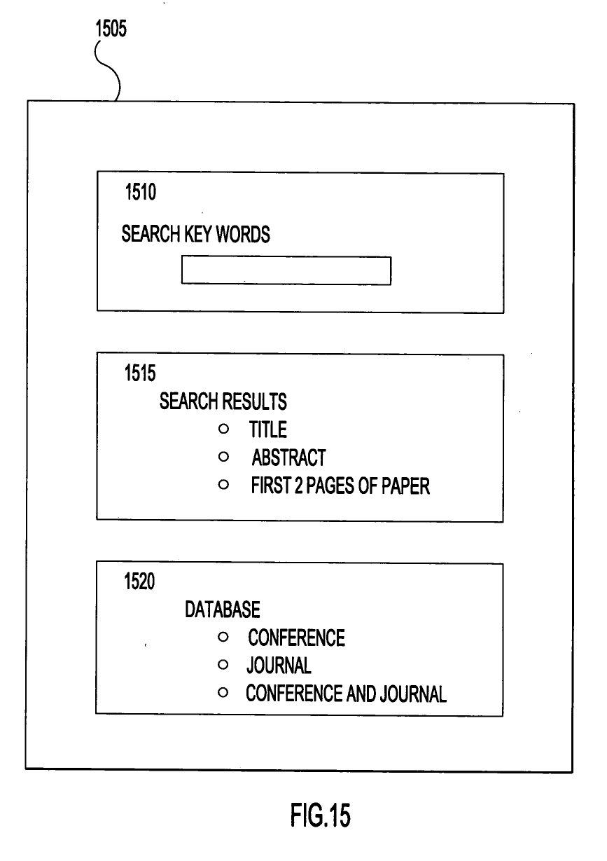

FIG. 15 depicts an example of the query interface 1505 which is presented to a paying user. The interface 1505 collects parameter values from a user. Compared with the interface depicted at 1405 in FIG. 14, the interface 1505 for the paying user collects more specific parameters value so that a more specific query or search can be initiated. In 1510, a user can specify specific keywords for the query to initiate a search. In 1515, the user can also specify the type of search results desired. For example, if the user is searching for articles, he can specify whether he wants to look at the title, the abstract, or the first two pages of each paper. In 1520, the user can specify the databases against which the query will be executed.

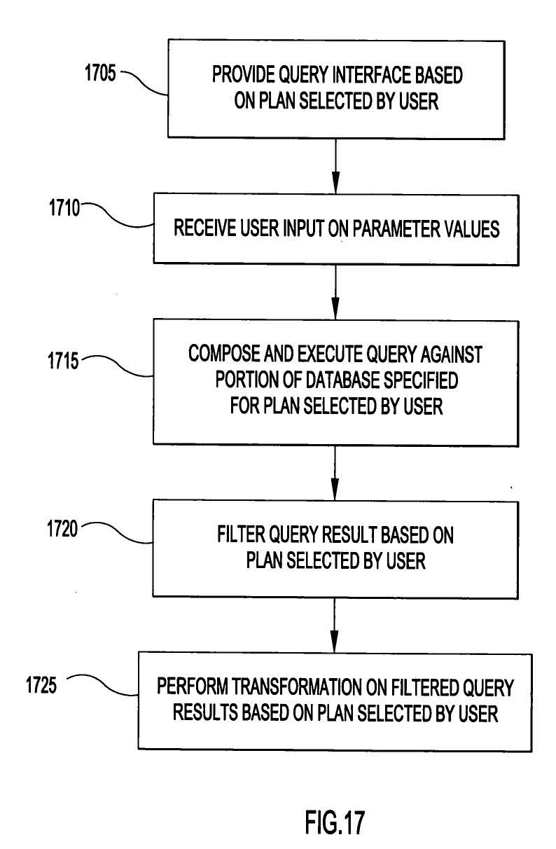

FIG. 16 depicts an example of a query plan management (QPM) process flow. In step 1605, the QPM receives a user request to access information. In step 1610, the QPM determines whether the request is for a free trial access. If so, in step 1615, the QPM selects the default query plan for free access. The default query plan is the most restricted plan (i.e., the plan with the highest degree of proprietary information protection). Nonetheless, it will still reveal enough information to show the capability of the query server and to entice the user to pay for a less restricted plan. In step 1620, for the case where the user is willing to pay for a less restricted query plan, QPM provides a list of query plans and associated fees from which the user can select the plan that would best fit his needs. In step 1625, the user selects one of the plans and makes payment accordingly. In step 1630, the query plan execution routine is invoked, as further detailed with reference to FIG. 17. In step 1640, the final query result is send back to the user. After examining the result, if the user is not satisfied that he has obtained all the information needed, and there is a good indication that the user can get the needed information by issuing another query against the server, as determined at step 1650, the user can return to step 1605 and reiterate the process. In the alternative, the user may be prompted to return to step 1620 at which the list is displayed for user selection of a different plan. In general, the user can go through several iterations to progressively relax the constraints and get more and more detailed information.

FIG. 17 depicts an example of the query plan execution routine from box 1630 of FIG. 16. In step 1705, the routine provides a query interface to the user. The presented query interface is based on the query plan selected by the user. The user can then fill in the parameter values and specify alternative choices provided on the query interface. In step 1710, the system receives the user input on the displayed parameter values. In step 1715, a query is composed according to the query plan selected and the input parameter values. The query is then executed against a portion or a view of the databases. In step 1720, the query result is then filtered based on the query plan selected. In step 1725, a transformation is applied to the result from step 1720. This transformation is based on the query plan selected and can be applied to a portion of the data. For example, in text search, encryption can be applied to every other paragraph of the documents returned from the query search. As noted above, while all of the proprietary information handling techniques (i.e., query restriction, data restriction, result filtering, and result transformation) are shown in the FIG. 17 process flow, different combinations of all or less than all of the techniques can be employed.

To avoid the repeated execution from scratch of queries for the same user as he progressively chooses more relaxed query plans, the system can save the results from the previous query executions to speed up the execution of subsequent queries. FIG. 18 illustrates an example of a process flow which is an optimization of the process flow depicted in FIG. 17. Under the FIG. 18 optimization process, after steps 1705 and 1710, step 1805 is taken. (Steps 1715, 1720 and 1725 are now replaced by the steps in FIG. 18.) In step 1805, it is determined whether there is an accumulated result dataset available from one or more previous iterations. This accumulated result dataset has to be related to the more restricted versions of the current query plan. If no accumulated dataset is available, the query is composed and executed at 1810 and the query results are stored into an accumulated result dataset at step 1815. If such a dataset exists, in step 1820 an incremental query is composed to search for the additional information allowed by the new query plan, but not included in the previous query plans, hence not in the accumulated result dataset. For example, if the new query plan allows for access to both the conference and journal databases, while the previous plan only allowed access to the conference database, the incremental query will be issued only against the journal database. Once the incremental query has been composed, the query is executed at step 1830. In step 1840, the results from the incremental query are added to the accumulated result dataset. In step 1845, filtering technique is applied to the information in the accumulated result dataset. In step 1850, any appropriate transformation is applied to the filtered result.

Those skilled in the art will recognize that various kinds of optimization can be implemented. For example, if encryption is used in the result transformation (step 1650), the query server can simply send the encryption key to the user, upon user selection of a less restrictive plan, in order for the user to get more detailed information without requiring execution of an additional query. In another alternative embodiment, the query server can perform a complete search, generating complete results and storing those results in the accumulated result dataset. Thereafter, the server would simply apply the different filtering and transformation techniques to the results in the dataset based on the user-selected query plan.

In the case of image results retrieved from the databases, the earlier-described coarse view and residual view approach can be applied to the query results in place of, or in conjunction with, the filtering and/or transformation steps. Different intermediate views can be associated with the different query plans. For example, a coarse view can be specified as the result display level for the most restricted plan, with progressively more detailed views being offered for the progressively less restrictive plans. As a user moves toward less restrictive plans, the user can be provided with new views or with the information (i.e., residual views) necessary to synthesize composite views having more detail. Should a user not have synthesizing capabilities, the server could synthesize the more detailed views in the accumulated result dataset, much like retrieved incremental query results are added to the accumulated results dataset in accordance with FIG. 18. As an alternative embodiment, the entire composite image can be stored in the accumulated result dataset, with decomposition being performed as the filtering step. In yet another alternative embodiment, the space and frequency graph view element data structure could be stored in the accumulated result dataset with different view elements being retrieved based on the query plan.

The invention has been described with reference to several preferred embodiment. One having skill in the art may seek to modify the embodiment without departing from the spirit and scope of the invention as set forth in the appended claims.

What is claimed by the present invention is:

1. A method for the progressive selling of information from a seller to a customer comprising the steps of:
offering for sale at least one coarse view of the information; and
offering for sale a plurality of residual views that contain additional details of the information.

2. The method of claim 1 wherein said information comprises a first composite information view and wherein said method further comprises the steps of:
decomposing said first composite information view into at least one coarse view of the information and plurality of residual views, wherein the combination of said at least one coarse view and said plurality of residual views yields said first composite information view.

3. The method of claim 1 further comprising providing at least one of said coarse and said residual views to a customer.

4. The method of claim 3 further comprising charging said customer based upon the number of views delivered.

5. The method of claim 1 further comprising representing the information using a view element framework that manages the dependencies among the coarse and residual views.

6. The method of claim 5 wherein said offering comprises offering the views and view elements to a customer.

7. The method of claim 5, further comprising the step of constructing a view element dependency data structure.

8. The method of claim 7 further comprising using said view element dependency data structure to determine what views can be derived from a given set of views.

9. The method of claim 7 further comprising using the view element dependency data structure to determine what views can be generated by acquiring additional view elements.

10. The method of claim 7 further comprising using the view element dependency data structure to perform the analysis and synthesis processing of the view elements.

11. The method of claim 1 further comprising the step of said seller monitoring the views already available to said customer.

12. The method of claim 11 further comprising the step of notifying the customer of additional views which can be derived from at least one view already available to said customer.

13. The method of claim 11 further comprising the step of informing the customer about what additional views can be generated by purchasing at least one residual view to combine with at least one view already available to said customer.

14. The method of claim 7 wherein the view element dependency data structure comprises a space and frequency graph, wherein the view elements are nodes of the space and frequency graph, and the transition paths correspond to the space and frequency analysis and synthesis operations.

15. The method of claim 3, wherein said providing comprises delivering said view to the customer from one of the seller site and another site.

16. The method of claim 3 wherein said providing comprises enabling access to data already available at the customer site.

17. The method of claim 3 further comprising providing at least one program with said at least one view.

18. The method of claim 17 wherein said providing at least one program comprises enabling analyzing and synthesizing of views by said customer.

19. The method of claim 17 wherein said providing at least one program comprises transferring a Java applet to said customer.

20. A method for determining and tracking the information viewing rights of the customer comprising the steps of:
selling rights to the information views represented by nodes in a view element data structure, and
allocating rights to additional views and view elements that can be derived by analysis and synthesis processing from said information views.

21. The method of claim 20 wherein view analysis and synthesis processing is performed by said customer.

22. The method of claim 20 wherein said view analysis and synthesis processing is performed at said seller.

23. The method of claim 20 wherein said view analysis and synthesis processing is performed at a proxy location remote from said seller and said customer.

24. The method of claim 20 wherein said view analysis and synthesis processing is partitioned between the seller, the client and a proxy location.

25. A system for providing information to a customer device from a seller location comprising:
decomposition component for decomposing information into at least one coarse view and a plurality of residual views, wherein combination of said at least one coarse view and said plurality of residual views yields said information;
generating means for offering said at least one coarse view and said plurality of residual views; and
at least one view synthesis component for combining said at least one coarse view and said plurality of residual views.

26. The system of claim 25 wherein one of said at least one view synthesis component is located at said customer device.

27. The system of claim 25 wherein said client device is one of the group consisting of a hand-held computer, personal digital assistant, personal computer, smart phone, notebook computer, digital audio receiver or playback device, workstation, global positioning system device, wireless wrist watch, cellular phone and pager.
